(19) United States
(12) Patent Application Publication
(10) Pub. No.: US 2003/0175074 A1
(43) Pub. Date: Sep. 18, 2003

(54) Method of attaching a pin-like element, a component assembly and a centering pin

(76) Inventors: Richard Humpert, Rosbach v.d.H. (DE); Bernd Muller, Erlensee (DE); Michael Vieth, Bad Vilbel (DE)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/364,755

(22) Filed: Feb. 11, 2003

(30) Foreign Application Priority Data
Feb. 12, 2002 (DE) 102 05 683.8

(51) Int. Cl. F16B 1/00

(52) U.S. Cl. 403/345

(57) ABSTRACT

A method of attaching a pin-like element (10) for example a centering pin or a bolt element in a component (20), for example in the form of a plate or of a wall section of a housing, wherein the pin-like element (10) has a head part (12) with a larger transverse dimension and an end face (14) as well as a shaft part (16) with a smaller transverse dimension and wherein the head part merges via an at least generally radially extending contact surface (30) into the shaft part (16), is characterized in that an element (10) is selected having an axial length of the head part which is significantly smaller than the thickness of the component (20) at the point of attachment of the pin-like element, in that a stepped bore (22) is produced in the component having a first region (24) of larger diameter which receives the head part (12) of the element and a second region (26) which receives the shaft part (16) and has a diameter which is of the same size as or fractionally smaller than the diameter of this shaft part, wherein the first region (24) of the stepped bore has a depth, which is somewhat greater than a longitudinal dimension of the head part (12) from the end face (14) to the contact surface (30) and in that at least one notch (36) is introduced by material deformation in the edge region of the component around the opening of the region (24) of the stepped bore (22) of larger diameter which leads to a displacement of material of the component over the end face of the element at at least one point (38) and in this way secures the element (10) in the component (20) in the axial direction.

### RELATED APPLICATION

This application claims priority to German Application No. 102 05 683.8 filed Feb. 12, 2002.

### FIELD OF THE INVENTION

The present invention relates to a method of attaching a pin-like element, e.g. a centering pin or a bolt element, in a component, for example in the form of a plate or of a wall section of a housing, wherein the pin-like element has a head part with a larger transverse dimension and an end face as well as a shaft part with a smaller transverse dimension and wherein the head part merges via an at least generally radially extending contact surface into the shaft part. The invention further relates to a component assembly consisting of a pin-like element and a component. The invention moreover relates to a centering pin.

### BACKGROUND OF THE INVENTION

A method or a component assembly of the kind initially named can be seen from DE 93 212 96 U1. In this document, the pin-like element is designed as a countersunk head screw and is brought together with a prior conical sheet metal upset, with the conical sheet metal upset being pressed flat. The conical lower side of the countersunk head screw, which is provided with rotationally securing noses, comes to rest in a correspondingly shaped conical recess of the sheet metal part and sheet metal material is displaced by the pressing flat of the sheet metal upset into an annular groove which is provided directly beneath the conical countersunk head of the screw.

### SUMMARY OF THE INVENTION

The element is designed for metal sheet thicknesses which have approximately the axial height of the head part of the element. The sheet metal/element connection is not very resistant to pressing out forces which act from the thread end of the element in the direction of the head part of the element, since only relatively little material is present in the annular groove. No proposal can be found in this document to the effect that the element could also be designed as a centering pin.

It is usually expected of a centering pin that it can take up large shear forces and that, on the assembling of the component with the centering pin to another component, the pressing out forces which act on the centering pin must not result in a loosening of the centering pin in the component or to a pressing of the centering pin out of the component.

It is the object of the present invention to provide a method of the kind initially named as well as a component assembly in which a centering pin can be introduced into a thick plate or in a thick-walled component, wherein the element introduced in the component can take up high shear forces and has a good resistance to pressing out forces. Furthermore, the method should be relatively simple to carry out.

To satisfy this object method-wise an element is selected having an axial length of the head part which is significantly smaller than the thickness of the component at the point of attachment of the pin-like element and a stepped bore is produced in the component having a first region of larger diameter which receives the head part of the element and a second region which receives the shaft part and has a diameter which is of the same size or fractionally smaller than the diameter of the shaft part. The first region of the stepped bore has a depth which is somewhat greater than a longitudinal dimension of the head part from the end face to the contact surface. At least one notch is introduced by material deformation in the marginal zone of the component around the opening of the region of the stepped bore of larger diameter which leads to a displacement of material of the component over the end face of the element at at least one point and in this way secures the element in the component in the axial direction.

A corresponding component assembly is characterised in that the head part of the element has an axial length which is significantly smaller than the thickness of the component at the point of attachment of the pin-like element, in that a stepped bore is provided in the component having a first region of larger diameter which receives the head part of the element and a second region which receives the shaft part and has a diameter which corresponds to the diameter of the shaft part, with the first region of the stepped bore having a depth which is somewhat larger than a longitudinal dimension of the head part from the end face to the contact surface and in that at least one notch produced by material deformation is present in the marginal zone of the component around the opening of the region of the stepped bore of larger diameter, with the material of the component extending over the end face of the element adjacent to the notch and in this manner securing the element in the component in the axial direction.

The invention further relates to a centering pin in the form of a pin-like element which is introduced into a plate or a wall section of a housing, with the pin-like element having a head part with a larger transverse dimension and an end face, as well as a shaft part with a smaller transverse dimension, with the head part merging via a rounded or conical shoulder in the region of the end face of the head part into the end face of the head part.

Since the at least substantially radially extending contact surface of the head part of the element contacts the stepped shoulder of the stepped bore, a movement of the element through the component need no longer be feared, and indeed not even if it is realised as a bolt element.

The deformed material should overlap the end face of the bolt element at least at a peripheral position due to the deformation of the material of the component in the region of the notch; the element is therefore fastened in the component such that the risk of the element being pressed out of the component need no longer be feared.

The said construction, i.e. the element assembly formed by the element and the component assembly, is capable of taking up high shear forces which are exerted onto the element.

The attachment of the element to the component requires only the establishment of a stepped bore and a subsequent pressing process in order to fix the element in the component in form-fitted manner.

If the element is made as a bolt element and a security against rotation is required, this can take place in that either the head part and/or the shaft part of the element is provided in the region of the component with edges and/or grooves extending in the axial direction which result in a form-fitted connection with the component by displacement of material of the component on pressing the element into the stepped bore. Alternatively, or additionally, the head part of the element can also be deformed at some positions on the deformation of the material of the component, during the formation of the notch(es), in order to form a security against rotation.

Preferred embodiments of the method in accordance with the invention or of the component assembly or of the element can be seen from the dependent claims as well as from the following description of a preferred embodiment. They are shown in the drawings.

### BRIEF DESCRIPTION OF THE DRAWINGS

FIG. 1 is a cross-section through a component in the region of a stepped bore provided there;

FIG. 2 is a representation similar to that of FIG. 1, but with a centering pin which has been introduced into the stepped bore; and

FIG. 3 is an enlarged view of the joined arrangement of the centering pin and the component in the region of the end face of the component.

Referring to the Figures, it can be seen from FIG. 2 that a pin-like element 10, here in the form of a centering pin, has a head part 12 with a larger transverse dimension and an end face 14 as well as a shaft part 16 with a smaller transverse dimension. In the representation in accordance with FIG. 2, the shaft part is not shown in full length, but cut off. In a centering pin, a circularly cylindrical shaft part 16 is usually provided which ends in an end face with a chamfer (not shown) so that the centering pin is aligned, as a result of the chamfer, on the attaching of the component with the centering pin to a further component, with a bore provided in the further component.

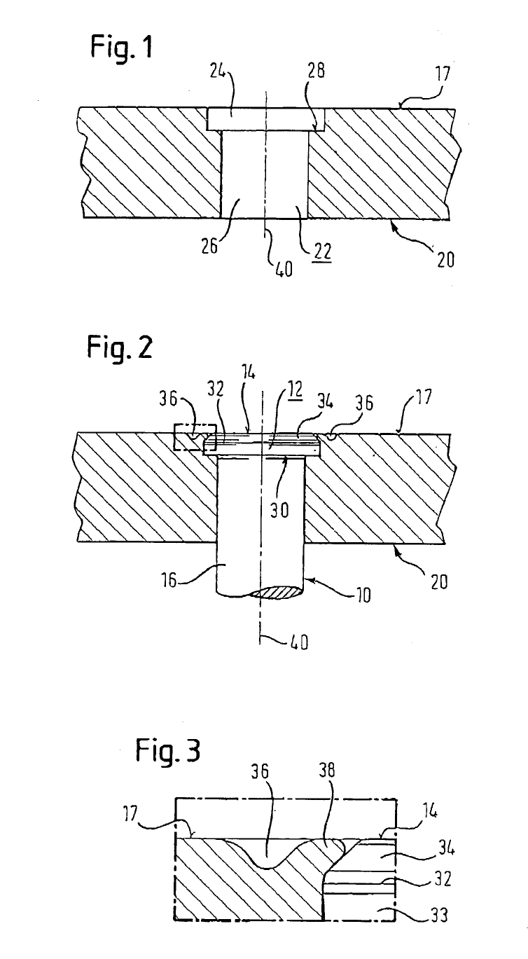

In the representation of FIG. 2, the upper side of the end face 14 of the element 10 lies flush with the side 17 of the component 20 remote from the shaft part 16. As can be seen from FIG. 1, the element 10 is located in a stepped bore 22 of the component 20. The stepped bore 22 has a first region 24 of larger diameter which, as shown in FIG. 2, receives the head part 12 of the element. Furthermore, the stepped bore 22 has a second region 26 having a diameter which is the same size or fractionally smaller than the diameter of the shaft part 16 of the element 10. The first region of the stepped bore has a depth between the side 17 of the component and the step surface or shoulder 28 of the stepped bore which corresponds to the maximum length of the head part 12 of the element, i.e. between the contact surface 30 of the element and the topmost surface of the end face 14 of the element in FIG. 2. In this manner, the end face 14 lies flush with the upper side 17 of the component. As can likewise be seen from FIG. 2, the head part 12 of the element 10 has a slightly rounded shoulder 32 which merges from a side wall 33 of the head part into a conical surface 34 which ultimately ends at the end face 14. The axial length of the head part 12 between the at least substantially radially extending contact surface 30, which sits on the step surface 28 of the stepped bore, and the rounded ring shoulder 32, is thus smaller than the depth of the first region of the stepped bore. In other words, the first region of the stepped bore has a depth which is somewhat larger than the length dimension of the head part from the rounded shoulder 32 to the contact surface 30.

As can be seen in FIG. 2, a notch 36 is provided in the upper side 17 of the component in a marginal zone of the component around the opening of the first region of the stepped bore, said notch 36 being produced by the action of a suitable pressing tool on the side 17 of the component. On the formation of the notch 36, which is ring-shaped in FIG. 2, material is displaced from the component 20 and forms a ring-shaped lip 38 which overlaps the rounded shoulder 32 and the conical surface 34 in a ring shaped manner, as can be seen from FIG. 3 to a larger scale. The head part 12 of the element is hereby held between the ring-shaped lip 38 and the step surface 28 of the stepped bore 22 in the axial direction and is thus secured against axial pressing out forces, i.e. forces which act in the axial direction 40 of the stepped bore or of the centering pin respectively.

The method for the manufacture of the component assembly in accordance with FIG. 2 is realised in the following manner. First, the stepped bore 22 is produced in the component 20, usually by a drilling process. Then, the centering pin is pressed into the stepped bore 22 by a pressing force produced from above in FIG. 2 by means of a suitable pressing tool which can be realised, for example, by a press or by a C-frame with a pressing apparatus carried by a robot. The component 20 is here supported at the lower side, for example on a die button which receives the shaft part 16 projecting out of the component, while an upper pressing tool presses onto the end face of the element until the contact surface 30 of the element 10 comes into abutment at the step surface 28 of the stepped bore. The notch 36 is now produced in the material of the component using the same pressing tool, or using a further pressing tool which is arranged concentrically to the tool, which effects the pressing in of the centering pin, with the material of the component simultaneously being reshaped to form the ring-shaped lip 38 by displacement of the material previously present in the notch.

The attachment of the centering pin in the component 20 can also take place in a progressive die tool set, in that the stepped bore 22 is produced in a first station by a drilling process, in that the centering element 10 is inserted into the stepped bore in a second station and in that the notch 36 is formed in a third station. It is also not absolutely necessary to produce the stepped bore in the progressive die tool set, but the component could be produced with the stepped bore 22 separately from the progressive die tool set.

The region 26 of the stepped bore 22 preferably has a diameter prior to the pressing in of the shaft part 16 of the centering pin 10 which is fractionally smaller than the outer diameter of the shaft part 16 of the centering pin. In other words, the centering pin is pressed in the component with a press fit. It is hereby ensured that the shaft part 16 of the centering pin is received in the component with clearance. This could only be ensured with difficulty if the second region 26 has a larger diameter than the diameter of the shaft part 16. Provision is therefore made that at least a high quality fit is present between the shaft part 16 and the second region 26 of the stepped bore 22 or, preferably, that a press fit is present.

When it is recited in the claims that the head part of the element has a larger transverse dimension and the shaft part has a smaller transverse dimension, then this wording takes into consideration that neither the head part nor the shaft part have to be circularly cylindrical, but it would also be quite feasible to provide the head part 12 and/or the shaft part 16 in the region of the component 20 with edges and/or grooves extending in the axial direction which, on being pressed into the stepped bore, result in a form-fitted connection to the component, coupled with a corresponding shaping of the component which is formed by the pressing in of the element. With a head part having grooves or having edges, a shape would then be present which deviates from a circular shape, but nevertheless has transverse dimensions. The same applies to the shaft part. There would, however, irrespective of which specific shape is selected for the head part or for the shaft part, always be a generally radially extending contact surface present between the head part and the shaft part, with the term “a generally radially extending contact surface” not precluding the fact that this surface could, for example, be present as a conical surface having a component which extends radially to the longitudinal axis of the element. In such a case, it would be favourable to give the step surface of the stepped bore a corresponding shape.

If a design of the head part 12 or of the shaft part 16 differing from the circular shape is provided, the form-fitted connection to the material of the component 20 results in a high quality security against rotation, which is admittedly not required in a centering element, but which could be quite useful in a realisation of the element as a bolt element.

It is also not absolutely necessary for the notch 36 to represent a ring-shaped notch around the axis 40. Instead of this, it could be sufficient to provide a notch only at one peripheral position of the marginal zone of the opening of the stepped bore 22, with it being better to provide a plurality of notches in the marginal zone distributed uniformly angle-wise.

The possibility also exists of carrying out the pressing of the component 20 in the region of the head part 12 of the element such that the material of the head part 12 is also deformed locally. An additional security against rotation would hereby be created with the correspondingly deformed material of the component. A further possibility to produce a security against rotation between the element and the component lies in providing noses ensuring security against rotation at the contact surface 30, for example noses which extend in the radial direction and are pressed, on the pressing of the element into the material of the component, into the step surface 28.

It is also not absolutely necessary for the topmost surface of the end face 14 to lie flush with the upper side 17 of the component 20. The surface 14 could also lie beneath the surface 17 or even above the surface 17. It is, however, important that a formation of the head part 12 is present which makes it possible to bring material from the component into overlap with the head part 12 in order to hereby ensure the axial security of the element in the component. Such an overlap takes place in the example of FIG. 2 in the region of the rounded shoulder 32 and of the conical surface 34 of the element 10, although the end face 14 itself lies flush with the surface 17. In other words, the axial length of the head part of the element is smaller in the region of the rounded shoulder than the depth of the first region 34 of the stepped bore 22.

Expression should also be given to the fact that edges extending in the axial direction can optionally be produced at the pin-like element 10 by a knurling process. Strictly speaking, it is also not necessary for the shaft part 16 to have a circularly cylindrical shape. A polygonal or grooved form could be provided instead of this, provided that this appears necessary or sensible for the function of the pin-like element. If such a cross-sectional shape is chosen for the pin-like element, it can be necessary to produce the region 26 of the stepped bore by a broaching process using a correspondingly shaped broaching needle.

The component 20 can be a plate made of metal or even of a suitable plastic. It can, however, also be a moulded part which consists of a moulding material which is deformable. For example, moulded parts of aluminium, die cast aluminium parts or moulded parts of magnesium or of steel would be possible. The component 20 could thus be a part of a housing which is produced from a corresponding material.

1. Method of attaching a pin-like element (10), for example a centering pin or a bolt element, in a component (20), for example in the form of a plate or of a wall section of a housing, wherein the pin-like element (10) has a head part (12) with a larger transverse dimension and an end face (14) as well as a shaft part (16) with a smaller transverse dimension and wherein the head part merges via an at least generally radially extending contact surface (30) into the shaft part (16),
characterized in that
an element (10) is selected having an axial length of the head part which is significantly smaller than the thickness of the component (20) at the point of attachment of the pin-like element, in that a stepped bore (22) is produced in the component having a first region (24) of larger diameter which receives the head part (12) of the element and a second region (26) which receives the shaft part (16) and has a diameter which is of the same size as or fractionally smaller than the diameter of this shaft part, wherein the first region (24) of the stepped bore has a depth, which is somewhat greater than a longitudinal dimension of the head part (12) from the end face (14) to the contact surface (30) and in that at least one notch (36) is introduced by material deformation in the edge region of the component around the opening of the region (24) of the stepped bore (22) of larger diameter which leads to a displacement of material of the component over the end face of the element at least one point (38) and in this way secures the element (10) in the component (20) in the axial direction.

2. Method in accordance with claim 1,
characterized in that
the head part (12) has a rounded and/or conical shoulder (32) in the region of the end face (14) against which the displaced material (38) is brought into contact.

3. Method in accordance with claim 1,
characterized in that
the stepped bore (22) is so designed that the end face (14) of the element (10) does not project beyond the side (17) of the component remote from the shaft part (16).

4. Method in accordance with claim 1,
characterized in that
the stepped bore (22) is so designed that the end face (14) of the element (10) lies flush with the side (17) of the component remote from the shaft part (16).

5. Method in accordance with claim 1,
characterized in that
the notch (36) is designed in ring-like shape and in that the displaced material of the component correspondingly extends in ring-like manner around the end face (14) of the head part (12) and overlaps the latter in the marginal zone.

6. Method in accordance with claim 1,
characterized in that
a plurality of notches (36) are provided in the component (20) around the longitudinal axis (40) of the element (10) and are preferably at least substantially uniformly distributed around this longitudinal axis.

7. Method in accordance with claim 1,
characterized in that
with an element in which a security against rotation is desired, either the head part and/or the shaft part is provided in the region of the component with edges and/or grooves extending in the axial direction which, on being pressed into the stepped bore, lead to a form-fitted connection to the component.

8. Method in accordance with claim 4,
characterized in that
during the deformation of the material of the component and the formation of the notch(s) the head part of the element is also deformed locally in order to form a security against rotation.

9. Method in accordance with claim 1,
characterized in that
the pressing of the element (10) into the component takes place in that the component (20) is supported at the shaft side of the element (10) for example on a die button which receives the shaft part projecting out of the component and in that a pressing force is exerted on the end face (14) of the element and on the component (20) in the region around the head part (12) by means of a tool which brings the contact surface of the element into abutment with the step surface (28) of the stepped bore (22) and simultaneously or subsequently effects the notch formation (36) and the material displacement.

10. Component assembly comprising a pin-like element, for example a centering pin or a bolt element and a component, for example in the form of a plate or of a wall section of a housing, wherein the pin-like element has a head part with a larger transverse dimension and an end face, as well as a shaft part with a smaller transverse dimension, and wherein the head part merges via a generally radially extending contact surface into the shaft part,
characterized in that
the head part of the element has an axial length which is significantly smaller than the thickness of the component at the point of attachment of the pin-like element, in that a stepped bore is provided in the component having a first region of larger diameter which receives the head part of the element and a second region which receives the shaft part and has a diameter which corresponds to the diameter of the shaft part, wherein the first region of the stepped bore has a depth which is somewhat larger than a longitudinal dimension of the head part from the end face to the contact surface and in that at least one notch produced by material deformation is present in the marginal zone of the component around the opening of the region of the stepped bore of larger diameter and the material of the component extends adjacent to the notch beyond the end face of the element and in this manner secures the element in the component in the axial direction.

11. Component assembly in accordance with claim 10,
characterized in that
the head part has, in the region of the end face, a rounded and/or conical shoulder which is contacted by the material of the component.

12. Component assembly in accordance with claim 10,
characterized in that
the end face of the pin-like element does not project beyond the side of the component remote from the shaft part.

13. Component assembly in accordance with claim 10,
characterized in that
the end face of the pin-like element lies flush with the side of the component remote from the shaft part.

14. Component assembly in accordance with claim 10,
characterized in that
the notch is of ring-like design and material of the component extends in ring-like manner around the end face of the head part and covers this over in the marginal zone.

15. Component assembly in accordance with claim 10,
characterized in that
a plurality of notches are provided in the component around the longitudinal axis of the element and are preferably at least substantially uniformly distributed around this longitudinal axis.

16. Component assembly in accordance with claim 10,
characterized in that
edges and/or grooves are provided at the head part and/or at the shaft part in the region of the component and stand in a form-fitted connection with the component.

17. Component assembly in accordance with claim 13,
characterized in that
the head part of the element is deformed in the region of the notch in the component, with a security against rotation being formed at the position of the deformation of the interengaging material of the component and of the element.

18. Component assembly in accordance with claim 10,
characterized in that
the contact surface of the element contacts the step surface of the stepped bore.

19. Centering pin for use in the component assembly in accordance with claim 10, wherein the centering pin is introduced into a plate or a wall section of a housing, with the pin-like element having a head part with a larger transverse dimension and an end face, as well as a shaft part with a smaller transverse dimension, with the head part merging via a rounded or conical shoulder in the region of the end face of the head part into the end face of the head part.
